(19) United States
(12) Patent Application Publication
(10) Pub. No.: US 2013/0070197 A1
(43) Pub. Date: Mar. 21, 2013

(54) EYEGLASSES ASSEMBLY

(71) Applicant: Yung-Chang CHANG, Chiayi (TW)

(72) Inventor: Yung-Chang CHANG, Chiayi (TW)

(21) Appl. No.: 13/350,147

(22) Filed: Jan. 13, 2012

(30) Foreign Application Priority Data
Sep. 19, 2011 (TW) 100217520

(51) Int. Cl. G02C 1/00

(52) U.S. Cl. 351/154

(57) ABSTRACT

In an eyeglasses assembly, a lens frame has two rims to surround a pair of lenses, respectively. Each rim has an inner peripheral surface extending transversely of the respective lens, a first annular stop wall projecting inwardly from the inner peripheral surface to contact a front or rear surface of the respective lens, and an annular recess defined by the inner peripheral surface and the first annular stop wall. Two clamp rings are received in the annular recesses of the respective rims to contact the rear or front surface of the respective lenses and to engage detachably the respective rims. Each clamp ring clamps the respective lens against the respective first annular stop wall.

### CROSS-REFERENCE TO RELATED APPLICATION

This application claims priority of Taiwanese Patent Application No. 100217520, filed on Sep. 19, 2011.

### BACKGROUND OF THE INVENTION

1. Field of the Invention

The invention relates to an eyeglasses assembly, and more particularly to an eyeglasses assembly that can generate a 3D visual effect.

2. Description of the Related Art

With an increasing development of technology, technology of 3D (three dimensional) viewing glasses which can produce a 3D visual effect from a 2D (two dimensional) planar images has become matured. The most widely used 3D eyeglasses assembly is a chromatic aberration eyeglasses assembly, which has a pair of lenses with different colors, such as red and blue, green and red, blue and yellow, etc. The lenses filter different polarized lights so that the two eyes of the user can see differently colored images, which produce a 3D visual effect.

The aforementioned type of 3D eyeglasses assembly typically includes a lens frame having a pair of annular rims for holding the pair of the lenses. During assembly, the lenses are placed at the outer lateral sides of the respective annular rims, and a high frequency welding machine is used to press and melt the connection portions of the lenses and the respective annular rims for joining the same together. However, there are some disadvantages in manufacturing and using the aforementioned 3D eyeglasses assembly.

Firstly, because the lens frames are injection molded, they tend to vary in thickness within a tolerance range from batch to batch. If the lens frames are relatively thick, they may be subjected to excessive welding pressure and heat which can cause deformation of the lens frame and the lenses. If the thickness of the lens frames is relatively small, the welding pressure may be insufficient resulting in an inefficient welding connection between the annular rims and the lenses. Therefore, the rate of producing defective products can be relatively high in manufacturing the aforesaid eyeglass assembly. To remedy the aforesaid problems, it is necessary to adjust the high frequency welding machine to accommodate different thickness of the lens frames. However, frequent adjustment of the welding machine for different batches of the lens frames is inconvenient and troublesome.

Furthermore, due to an increasing demand for the 3D eyeglasses assemblies, more and more high frequency welding machines are needed to manufacture the 3D eyeglasses assemblies. The manufacturing cost can be increased significantly when manufacturing a large number of the 3D eyeglasses assemblies.

In addition, since the 3D eyeglasses are commonly used in movie theaters, theme parks, stereo theaters in the museums, the 3D eyeglasses after use are usually collected, cleaned and examined for reuse. When a scratch is found on the surface of one of the lens in the lens frame, because the lens is welded to the lens frame, the lens cannot be replaced, and the entire eyeglass assembly is discarded wasting natural resources and raw materials.

Moreover, because the 3D eyeglasses are assembled using the high frequency welding machine that can melt parts of the lenses and the lens frame, the surfaces of the lenses and the lens frame are not suitable to be formed with a coating that is venerable to the heat of welding. As a result, surface modification of the lenses and the lens frame is impossible, and the application of the eyeglasses assembly is limited.

### SUMMARY OF THE INVENTION

An object of the present invention is to provide an eyeglasses assembly that is easy for assembly and that can be manufactured at low costs.

Another object of the present invention is to provide an eyeglasses assembly that permits easy replacement of component parts.

Accordingly, an eyeglasses assembly of this invention comprises a pair of lenses, a lens frame and a pair of clamp rings. Each of the lenses has front and rear surfaces. The lens frame includes a pair of rims respectively surrounding the lenses, and a bridge disposed between the rims. Each of the rims has an inner peripheral surface extending transversely of the front and rear surfaces of a respective one of the lenses, a first annular stop wall projecting inwardly from the inner peripheral surface to contact one of the front and rear surfaces of the respective one of the lenses, and an annular recess defined by the inner peripheral surface and the first annular stop wall.

Each of the clamp rings is disposed in a respective one of said rims oppositely of said first annular stop wall. Each of the clamp rings is disposed in the annular recess to contact the other one of the front and rear surfaces of the respective one of the lenses and is detachably engaged with the respective one of the rims. Each of the lenses is clamped between one of the clamp rings and the first annular stop wall of one of the rims.

### BRIEF DESCRIPTION OF THE DRAWINGS

Other features and advantages of the present invention will become apparent in the following detailed description of the preferred embodiments with reference to the accompanying drawings, of which:

FIG. 1 is a perspective view of the first preferred embodiment of an eyeglasses assembly according to the present invention;

FIG. 2 is a fragmentary exploded perspective view of the first preferred embodiment;

FIG. 3 is a fragmentary side sectional view of the first preferred embodiment;

FIG. 4 is a fragmentary exploded perspective view of the second preferred embodiment of an eyeglasses assembly according to the present invention;

FIG. 5 is a fragmentary side sectional view of the second preferred embodiment;

FIG. 6 is a fragmentary exploded perspective view of the third preferred embodiment of an eyeglasses assembly according to the present invention;

FIG. 7 is a fragmentary exploded perspective view of the fourth preferred embodiment of an eyeglasses assembly according to the present invention;

FIG. 8 is a fragmentary exploded perspective view of the fifth preferred embodiment of an eyeglasses assembly according to the present invention;

FIG. 9 is a fragmentary side sectional view of the fifth preferred embodiment; and

FIG. 10 is a fragmentary exploded perspective view of the sixth preferred embodiment of an eyeglasses assembly according to the present invention.

### DETAILED DESCRIPTION OF THE PREFERRED EMBODIMENTS

Before the present invention is described in greater detail with reference to the accompanying preferred embodiments, it should be noted herein that like elements are denoted by the same reference numerals throughout the disclosure.

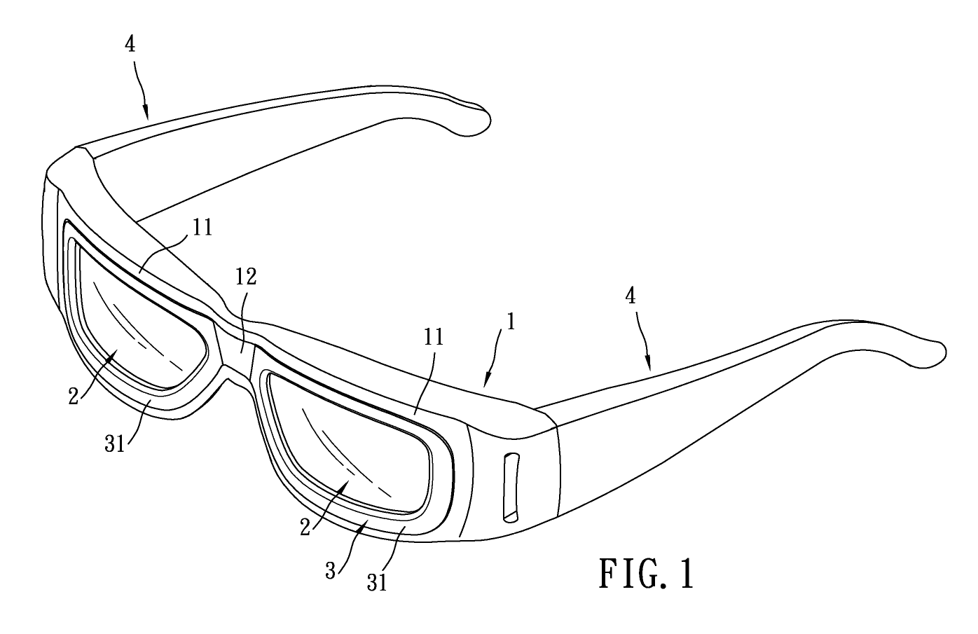

Referring to FIGS. 1 to 3, the first preferred embodiment of an eyeglasses assembly according to the present invention comprises a lens frame 1, a pair of lenses 2, a clamp ring unit 3 having a pair of clamp rings 31, and a pair of temples 4.

Each of the lenses 2 has a rear surface 21 adapted to face an eye of the user, and a front surface 22. The lenses 2 may be a pair chromatic aberration lens with different colors, or a pair of polarized-light lens to filter polarized lights. Since the lenses 2 are well known in the art, they are not detailed hereinafter.

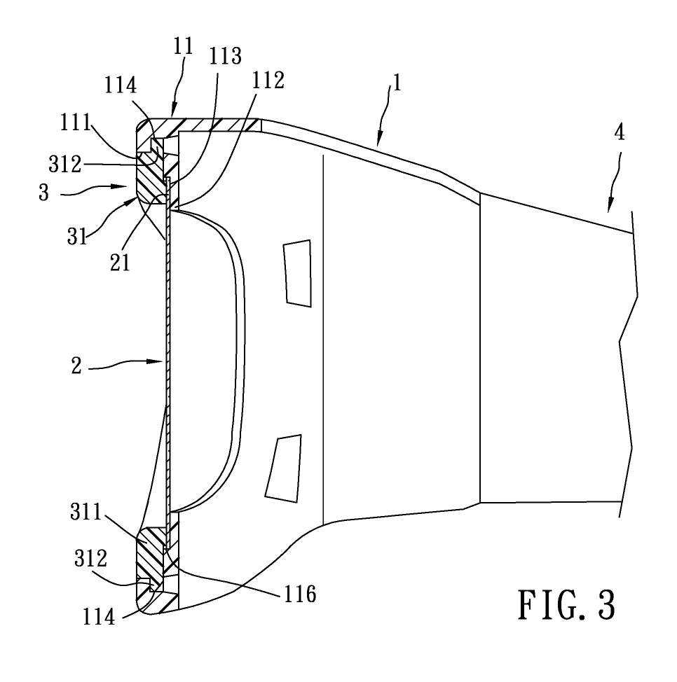

The lens frame 1 includes a pair of rims 11 respectively surrounding the lenses 2, and a bridge 12 disposed between the rims 11. Each of the rims 11 has an inner peripheral surface 111 surrounding the respective lens 2 and extending transversely of the rear and front surfaces 21, 22 of the respective lens 2, and a first annular stop wall 112 projecting inwardly from a rear end of the inner peripheral surface 111 to contact the rear surface 21 of the respective lens 2. An annular recess 113 is defined by the inner peripheral surface 111 and the first annular stop wall 112. A lens-retaining recess 116 is formed on the first annular stop wall 112 to receive the respective lens 2. The width of the lens-retaining recess 116 is smaller than that of the annular recess 113. Each of the rims 11 further has a plurality of annularly spaced first engaging elements 114 formed in the inner peripheral surface 111 in spatial communication with the annular recess 113. In this embodiment, the first engaging elements 114 includes annularly spaced apart engaging slots which are formed in top, bottom, left and right sides of the inner peripheral surface 111. In practice, the first engaging elements 114 should not be limited to those described hereinabove. The first engaging elements 114 may as well be formed in the corners of the inner peripheral surface 111, and the number of the first engaging elements 114 may be increased or decreased according to the shape of the inner peripheral surface 111. For example, two first engaging elements 114 may be disposed in one side of the inner peripheral surface 111. For easy removal of the lens frame 1 from a forming mold during molding the lens frame 1, the engaging slots of the first engaging elements 114 may be arranged to penetrate the first annular stop wall 112 as best shown in FIG. 3. Of course, the engaging slots may also be arranged to penetrate a front edge of the respective rim 11.

The clamp rings 31 are disposed respectively in the rims 11 oppositely of the respective first annular stop walls 112 of the rims 11. Each of the clamp rings 31 is detachably received in the annular recess 113 of the respective rim 11 to contact the front surface 22 of the respective lens 2 and is engaged with the respective rim 11. In particular, each clamp ring 31 has a second annular stop wall 311 to contact the front surface 22 of the respective lens 2, and a plurality of annularly spaced apart second engaging elements 312 to engage the first engaging elements 114, respectively. In this embodiment, the second engaging elements 312 include annularly spaced apart protrusions to engage the engaging slots of the respective first engaging element 114. With use of the clamp rings 31, each of the lenses 2 can be clamped between the respective clamp ring 31 and the respective first annular stop wall 112. While the first and second engaging elements 114, 312 are configured respectively as the engaging slots and the protrusions, the first engaging elements 114 may be the protrusions and the second engaging elements 312 may be the engaging slots according to the pre sent invention. Of course, the first and second engaging elements 114, 312 may have any suitable configurations as long as they can be interlocked releasably.

The temples 4 are connected pivotably and respectively to two opposite ends of the lens frame 1, and are operable to move between a folded position and an unfolded position.

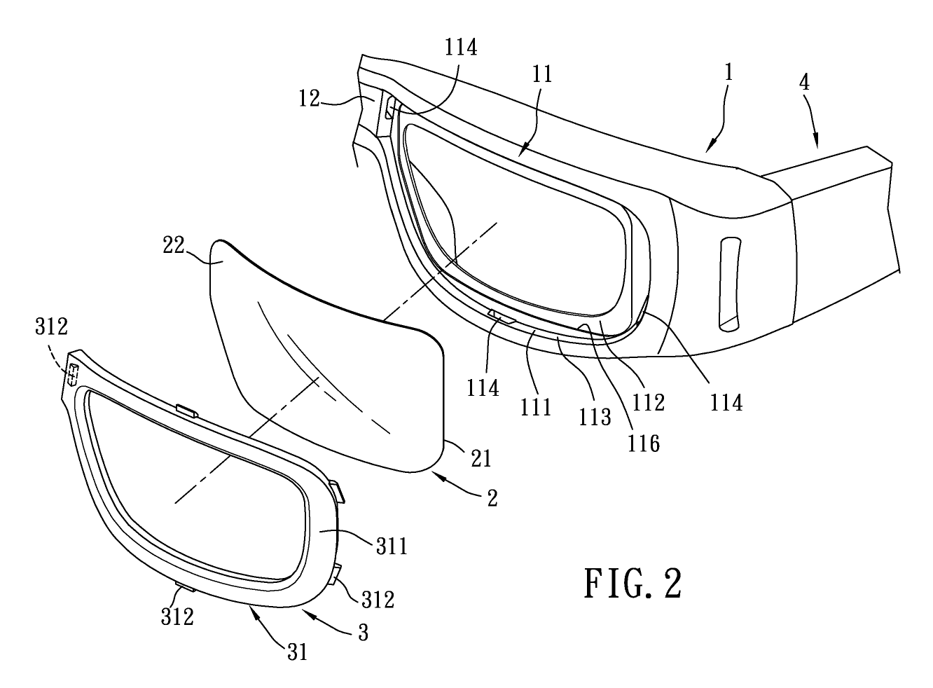

Referring back to FIG. 2, to assemble the lens 2 with the respective rim 11 of the lens frame 1, the lens 2 may be first placed in the lens-retaining recess 116 formed in the first annular stop wall 112 such that the rear surface 21 of the lens 2 is in contact with the first annular stop wall 112. The lens 2 is then clamped in the respective rim 11 by fitting the respective clamp ring 31 in the annular recess 113 of the respective rim 11. To fit the clamp ring 31 in the respective rim 11, one side of the second annular stop wall 311 of the clamp ring 31 that has two second engaging elements (protrusions) 312 may be first inserted into the rim 11 by slightly inclining the clamp ring 31 to engage the two second engaging elements 312 with the respective first engaging elements 114. Thereafter, the top and bottom sides of the second annular stop wall 311 are pressed into the rim 11 so that the second engaging elements 312 are deformed and squeezed into the rim 11 and are engaged in the respective engaging elements 114. The second annular stop wall 311 therefore abuts against the front surface of the lens 2 and clamps the lens 2 against the first annular stop wall 112.

When replacement of the lens 2 is required, the clamp ring 31 may be detached from the respective rim 11 by separating the second engaging elements 312 from the respective first engaging elements 114 using a hand tool or a rod piece. Separation may be performed by applying a force from a rear side of the lens frame 1 using the hand tool or the rod piece, or by inserting the hand tool between the clamp ring 31 and the respective rim 11 to push off the second engaging elements 312. Because the lens frame 1 and the clamp rings 31 are made of a flexible or bendable plastic material, the clamp rings 31 can be attached to and detached from the respective rims 11 easily.

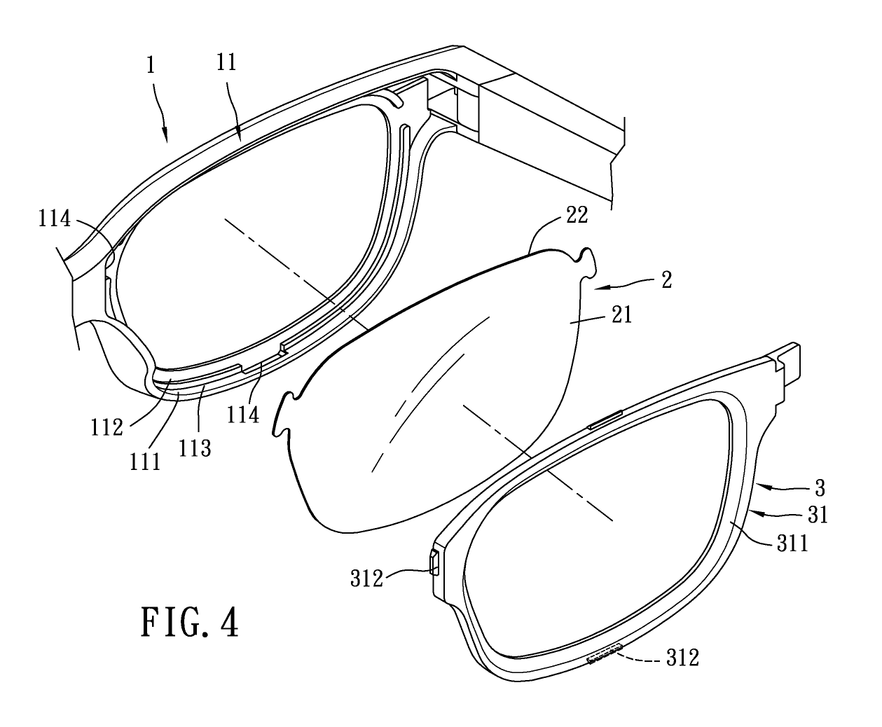

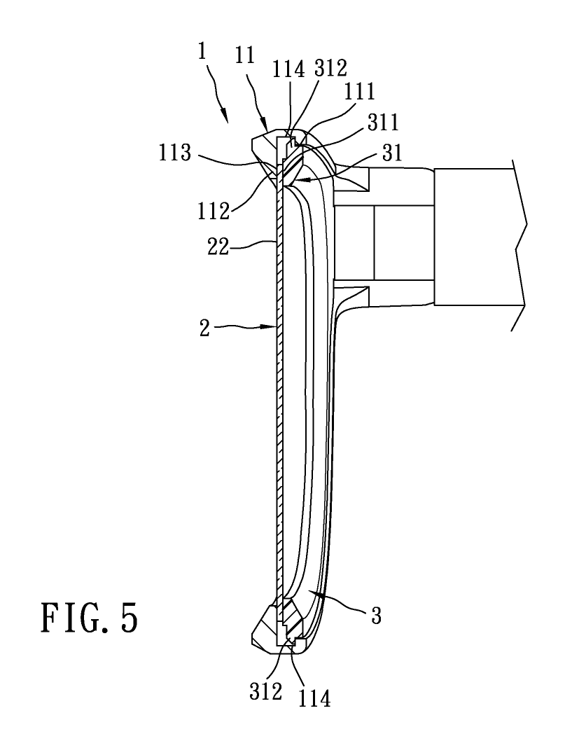

Referring to FIGS. 4 and 5, the second preferred embodiment of an eyeglasses assembly according to this invention is generally similar to the first preferred embodiment except that the first annular stop wall 112 of each rim 11 projects inwardly from a front end of the inner peripheral surface 111 to contact the front surface 22 of the respective lens 2 and that the clamp ring 31 is fitted in the respective rim 11 from the rear side of the rim 11 to contact the rear surface 21 of the lens 2.

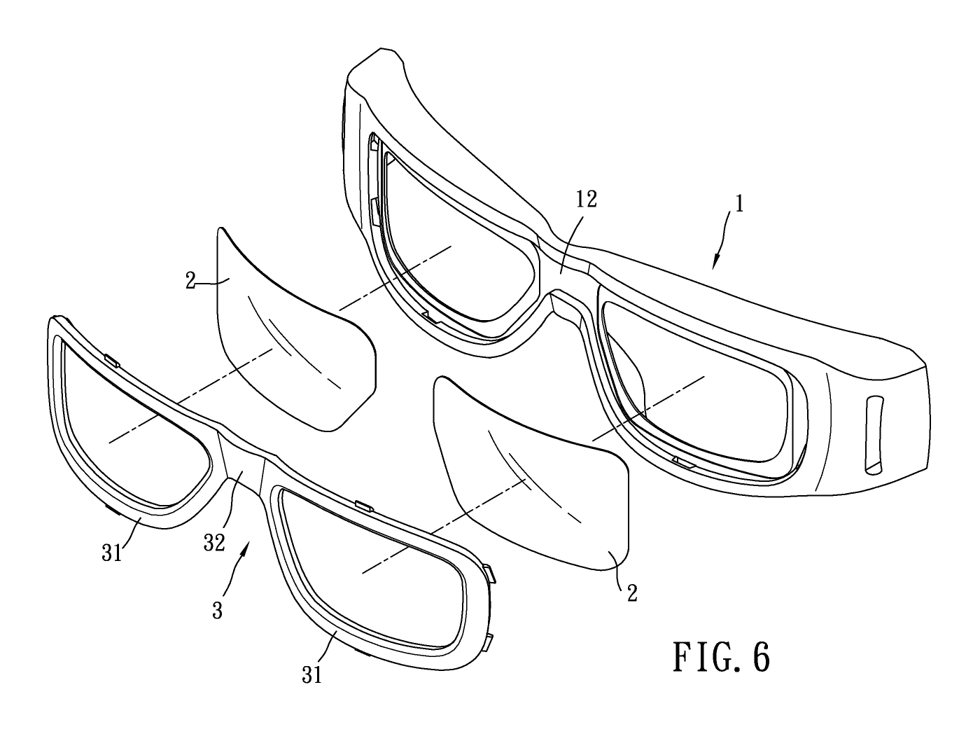

Referring to FIG. 6, the third preferred embodiment of an eyeglasses assembly according to this invention is generally similar to the first preferred embodiment. However, the two clamp rings 31 are interconnected each other. In particular, the clamp rings 31 have a connection element 32 that interconnects the clamp rings 31 at a location corresponding to that of the bridge 12. As such, the clamp rings 31 can be attached and detached from the lens frame 1 as a whole.

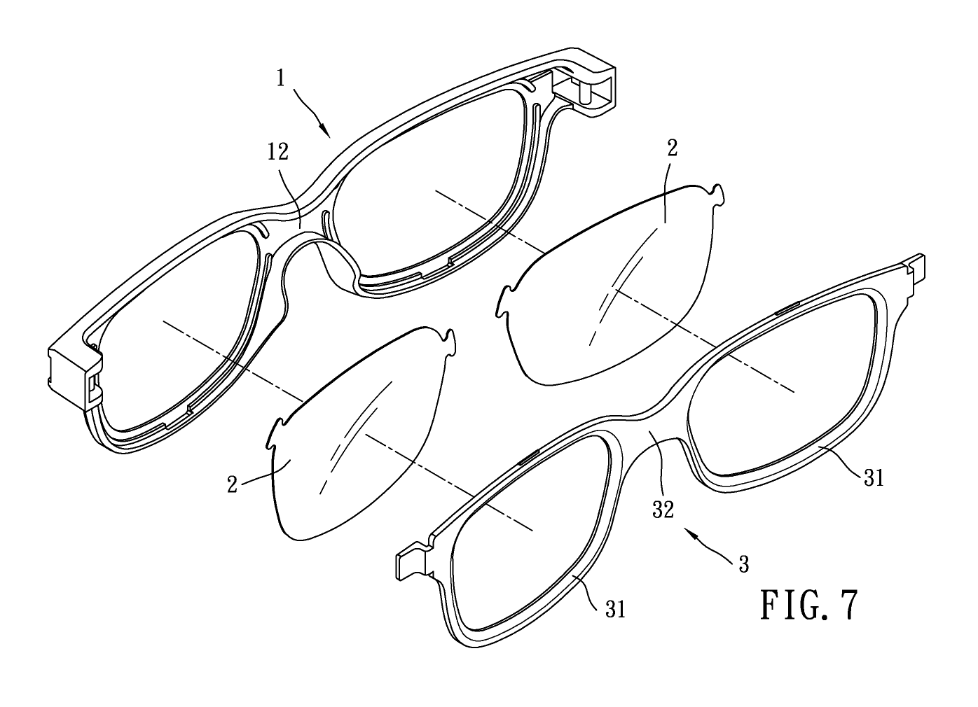

Referring to FIG. 7, the fourth preferred embodiment of the eyeglasses assembly according to this invention is generally similar to the second preferred embodiment. However, the clamp rings 31 have a connection element 32 that interconnects the clamp rings 31 at a location corresponding to that of the bridge 12.

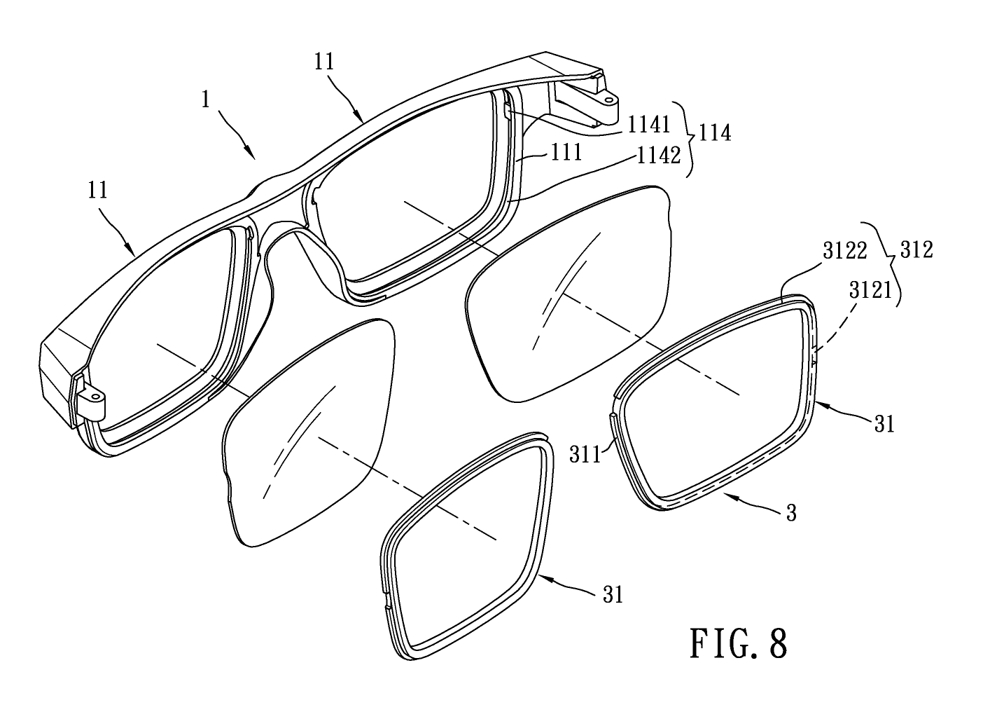

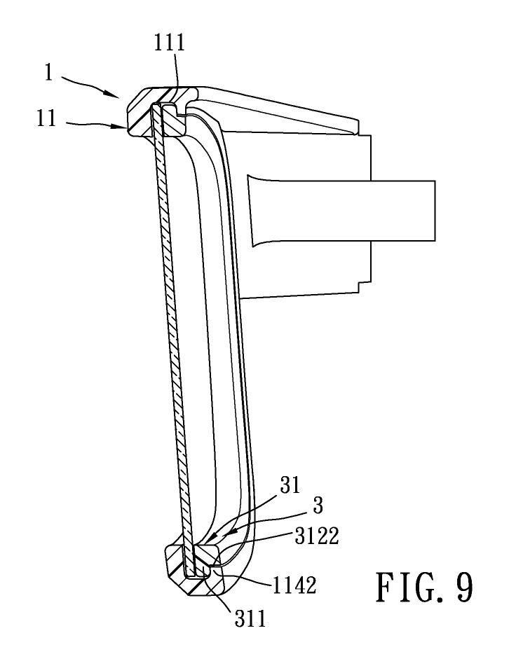

Referring to FIGS. 8 and 9, the fifth preferred embodiment of the eyeglasses assembly according to this invention is generally similar to the second preferred embodiment. However, the fifth preferred embodiment is provided with a reinforced engagement between the lens frame 1 and the clamp rings 31. In particular, the first engaging elements 114 includes the protrusions 1141 and a rib 1142, both of which project inwardly from the inner peripheral surface 111 of each rim 11, and the second engaging elements 312 includes engaging slots 3121 and a groove 3122, both of which are formed on an outer periphery of each clamp ring 31. The rib 1142 extends annularly along the inner peripheral surface 111 of the rim 11, and the groove 3122 extends annularly along the outer periphery of the clamp ring 31. While the protrusion 1141 and the rib 1142 are formed on the rims 11, and the engaging slot 3121 and the groove 3122 are formed on the clamp rings 31, they may be interchanged so that the protrusion 1141 and the rib 1142 are formed on the clamp rings 31, and the engaging slot 3121 and the groove 3122 are formed on the rims 11.

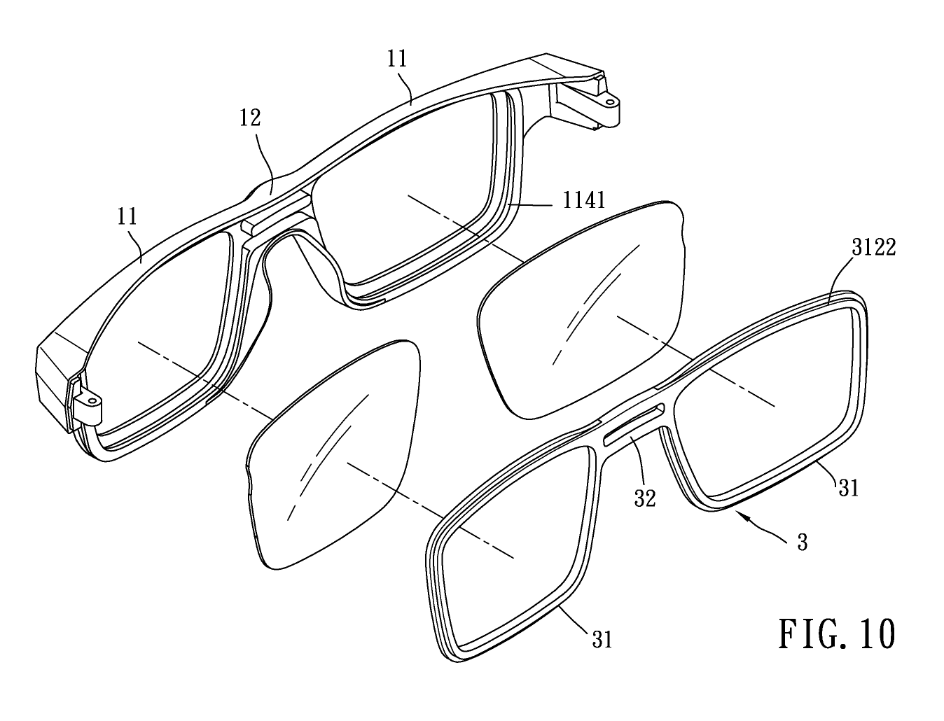

Referring to FIG. 10, the sixth preferred embodiment of the eyeglasses assembly according to this invention is generally similar to the fifth preferred embodiment except that the clamp rings 31 are interconnected by the connection element 32 and that the protrusion 1141 and the engaging slot 3121 are eliminated.

With use of the clamp rings 31 and the first and second engaging elements 114, 312 in the present invention, the lenses 2 can be assembled with the lens frame 1 without the need of the high frequency welding machine used in the prior art. Therefore, the process of assembly is simplified, and the manufacturing and equipment costs can be reduced. Furthermore, because the uneven thickness of the lens frame 1 will not affect assembly of the lens frame 1 and the lens 2, the production rate of good quality products can be increased. Since the lens frame 1 and the lenses 2 are not subjected to the heat of welding during assembly, deformation problems can be eliminated, and the surfaces of the lens frame 1 and the lenses 2 can be coated to improve functional and physical properties of the eyeglasses assembly.

In addition, because the two lenses 2 are releasably mounted to the lens frame 1, the two lenses 2 may be detached independently from the lens frame 1 for replacement. Therefore, the eyeglasses assembly need not be discarded entirely, thereby saving natural resources and raw materials.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. An eyeglasses assembly comprising:
a pair of lenses each having a rear surface adapted to face an eye of the user, and a front surface opposite to said rear surface;
a lens frame including a pair of rims respectively surrounding said lenses, and a bridge connected between said rims, each of said rims having an inner peripheral surface extending transversely of said front and rear surfaces of a respective one of said lenses, a first annular stop wall projecting inwardly from said inner peripheral surface to contact one of said front and rear surfaces of the respective one of said lenses, and an annular recess defined by said inner peripheral surface and the first annular stop wall; and
a clamp unit including a pair of clamp rings each mounted in a respective one of said rims and opposing said first annular stop wall, each of said clamp rings being mounted in said annular recess to contact the other one of said front and rear surfaces of the respective one of said lenses and being detachably engaged with the respective one of said rims;
wherein each of said lenses is clamped between a respective one of said clamp rings and said first annular stop wall of a respective one of said rims.

2. The eyeglasses assembly of claim 1, wherein each of said rims further has at least one first engaging element formed in said inner peripheral surface, each of said clamp rings having a second annular stop wall that contacts the other one of said front and rear surfaces of the respective one of said lenses and that has at least one second engaging element to engage said first engaging element.

3. The eyeglasses assembly of claim 2, wherein each of said rims has a plurality of annularly spaced said first engaging elements formed in said inner peripheral surface, said second annular stop wall having a plurality of annularly spaced apart said second engaging elements to engage said first engaging elements, respectively.

4. The eyeglasses assembly of claim 3, wherein each of said first engaging elements is an engaging slot, and each of said second engaging elements is a protrusion to engage said engaging slot.

5. The eyeglasses assembly of claim 1, wherein said clamp rings are separated from each other.

6. The eyeglasses assembly of claim 1, wherein said clamp unit further includes a connection element that interconnects said clamp rings at a location substantially corresponding to that of said bridge.

7. The eyeglasses assembly of claim 1, further comprising a pair of temples connected respectively to two opposite ends of said lens frame.

8. The eyeglasses assembly of claim 1, wherein said first annular stop wall projects inwardly from a rear end of said inner peripheral surface to contact said rear surface of the respective one of said lenses, and said second annular stop wall contacts said front surface of the respective one of said lenses.

9. The eyeglasses assembly of claim 1, wherein said first annular stop wall projects inwardly from a front end of said inner peripheral surface to contact said front surface of the respective one of said lenses, and said second annular stop wall contacts said rear surface of the respective one of said lenses.

10. The eyeglasses assembly of claim 2, wherein said first engaging element extends annularly along said inner peripheral surface, and said second engaging element extend annularly on an outer periphery of said second annular stop wall.

11. The eyeglasses assembly of claim 10, wherein said first engaging element is configured as a rib formed on and extending annularly along said inner peripheral surface, and said second engaging element is configured as a groove extending annularly and formed on an outer periphery of said second annular stop wall to engage said rib.

12. The eyeglasses assembly of claim 2, wherein each of said rims has a plurality of said first engaging elements formed in said inner peripheral surface, said second annular stop wall having a plurality of said second engaging elements formed on an outer periphery of said second annular stop wall, said first engaging elements including annularly spaced apart protrusions, and a rib formed on and extending annularly along said inner peripheral surface, said second engaging elements including annular spaced apart engaging slots to respectively engage said protrusions, and a groove extending annularly and formed on an outer periphery of said second annular stop wall to engage said rib.
